(19) United States
(12) Patent Application Publication
(10) Pub. No.: US 2024/0174152 A1
(43) Pub. Date: May 30, 2024

(54) BABIES FIRST

(71) Applicant: Jermain Anderson, Cincinnati, OH (US)

(72) Inventor: Jermain Anderson, Cincinnati, OH (US)

(21) Appl. No.: 18/072,646

(22) Filed: Nov. 30, 2022

(51) Int. Cl. B60N 2/90; B60N 2/00; B60N 2/26; B60Q 9/00; B60R 22/48

(52) U.S. Cl. CPC B60N 2/90; B60N 2/002; B60N 2/26; B60Q 9/00; B60R 22/48; B60N 2002/981

(57) ABSTRACT

A child car seat alert system for indicating the presence of child in a vehicle is disclosed. The system further detects a first state and a second state of the vehicle. The first state refers to the vehicle in a parked state and the presence of a caretaker in the vehicle. The second state refers to the vehicle in a parked state and the absence of the caretaker in the vehicle. The system activates an alarm module on detecting the child in the seat and the seatbelt fastened to the seat. The system prompts the alarm module to provide a first alert on detecting the first state to remind the caretaker to collect the child while exiting the vehicle. The system prompts the alarm module to provide a second alert on detecting the second state to indicate the child is left unattended in the vehicle.

### CROSS-REFERENCE TO RELATED APPLICATIONS

This application is a national stage application claims the benefit of priority under 35 U.S.C. § 119(e) to U.S. Provisional Application Ser. No. 63/284,918, entitled “BABIES FIRST”, filed Dec. 1, 2021, the contents of which are hereby incorporated by reference in their entirety for any purpose.

### BACKGROUND

### 1. Technical Field

The present invention relates to gene expression profiling to differentiate ischemic stroke, transient ischemic attack, and patients that present with stroke like symptoms caused by atrial fibrillation.

### 2. Description of the Related Art

A number of tragic deaths have occurred from children being inadvertently left in vehicles by a driver, a parent, or a caretaker. The deaths have usually been caused by a build-up of excess heat or cold within the vehicle during the absence of the caretaker. Often a child may be forgotten or left by the driver of the vehicle, such as the caregiver or the parent. For example, the driver may forgetfully leave a child within the vehicle due to some distraction. In another example, the child may fall asleep during a drive and remain quiet for a period of time. Upon arriving at a destination, the driver may be preoccupied or forgetful about the presence of the sleeping child. In yet another example, the unattended child may be kidnapped from the vehicle.

Regardless of whether the child left intentionally or unintentionally in the vehicle, the closed status of the vehicle causes a great risk of injury to the child. The internal weather conditions, such as high temperatures, can cause fatality in a short period of time. Even when fatality is not the result, the child may be left with serious and possibly permanent injury due to heat exhaustion or dehydration.

Devices, for example, a child safety car seat, have been developed to remind the presence of child in the vehicle. A conventional system comprises a mobile application and a child safety seat. The child safety seat is configured to remind the presence of the child in the vehicle. However, the mobile application of the system needs to be running at all times for the system to send reminder. Depending on the distance of the destination, the user device may run out of battery, which may lead to deactivation of the system.

Another conventional system comprises a child safety seat configured to indicate the presence of the child in the vehicle. However, the system is connected to the lighter port of the vehicle to receive the power supply. Such a system is not reliable when the vehicle engine is turned off. For example, the caretaker may turn off the vehicle to take a phone call and may forget the presence of child in the vehicle while exiting the vehicle. Additionally, the system relies on the vehicle power supply causes a delay in the sensor. Furthermore, the existing system provides a number of complex steps to activate the child safety car seat.

Therefore, there is a need for a system for indicating and alerting the presence of the child in the vehicle that overcomes the aforementioned drawbacks of the conventional systems.

### SUMMARY

A child car seat alert system for indicating and alerting the presence of the child in a vehicle is disclosed. The system comprises at least one child car seat having at least one first sensor to detect a presence of the child and at least one second sensor to detect fastening of the seatbelt of the child car seat. The system further comprises at least one third sensor configured to detect a first state and a second state of the vehicle. The first state refers to the vehicle being in a parked state and the presence of a caretaker in the vehicle, and the second state refers to the vehicle being in a parked state and the absence of the caretaker in the vehicle. The system further comprises an alarm module configured to receive power from a power source, and a control unit is in communication with the alarm module, the first sensor, the second sensor and the third sensor. The control unit is configured to activate the alarm module on detecting the presence of child in the car seat and the seatbelt fastened to the child car seat. The control unit is further configured to prompt the alarm module to provide a first alert on detecting the first state to remind the caretaker to collect the child while exiting the vehicle. The control unit is further configured to prompt the alarm module to provide a second alert on detecting the second state to indicate the child is left unattended in the child car seat. The second alert is broadcasted until the child is collected from the vehicle.

In one embodiment, the first sensor is a weight sensor. The alert is at least one of an audible alert and a musical type audible alert. In one embodiment, the power source is a rechargeable power source.

The system further comprises a speaker to provide at least one of the first alert and the second alert. The speaker is electrically connected to the power source. The speaker comprises a cord to electrically connect the speaker to a power socket. The power socket is at least one of a USB port, and a cigarette lighter port of the vehicle. The system further comprises a seatbelt button in communication with the control unit. The seatbelt is configured to provide an indication when the seatbelt is fastened to the child car seat, and provide an indication when the seatbelt is unfastened from the child car seat.

The system further comprises a timer in communication with the control unit. The control unit is configured to deactivate the alarm module on collecting the child from the child car seat. The control unit is configured to receive power from a power system of the vehicle. The power system includes an engine. The system further comprises a recorder in communication with the control unit, the recorder is configured to enable the caretaker to record the name of the child. The system is further configured to provide alert using the name of the child. The system is further configured to provide alert regarding the malfunction of the seatbelt.

### BRIEF DESCRIPTION OF THE DRAWINGS

FIG. 1 exemplarily illustrates a block diagram of a child car seat alert system for indicating and alerting the presence of child in a child car seat of a vehicle, according to an embodiment of the present invention.

FIG. 2 exemplarily illustrates a perspective view of a child car seat with a child, according to an embodiment of the present invention.

FIG. 3 exemplarily illustrates a perspective view of the child car seat of FIG. 2.

FIG. 4 exemplarily illustrates a side view of the child car seat of FIG. 2.

FIG. 5 exemplarily illustrates a seatbelt of the child car seat of FIG. 2 in an unfastened state.

FIG. 6 exemplarily illustrates the seatbelt of the child car seat of FIG. 2 in a fastened state.

FIG. 7 exemplarily illustrates the arrangement of a weight sensor and a speaker of the child car seat of FIG. 2.

FIG. 8 exemplarily illustrates the connection between the components of the child car seat alert system.

FIG. 9 exemplarily illustrates an environment where the alarm module is inactive when the child and the caretaker is within a moving vehicle.

FIG. 10 exemplarily illustrates an environment where the alarm module is providing alert when the system of FIG. 1 detects that the child is within the vehicle, and the caretaker has left the vehicle.

FIG. 11 exemplarily illustrates a USB cable of the system of FIG. 1 for connecting to a USB port of the vehicle.

FIG. 12 exemplarily illustrates a cable of the system of FIG. 1 for connecting to a cigarette lighter port.

FIG. 13 exemplarily illustrates a method for indicating and alerting the presence of child in a child car seat of a vehicle, according to an embodiment of the present invention.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

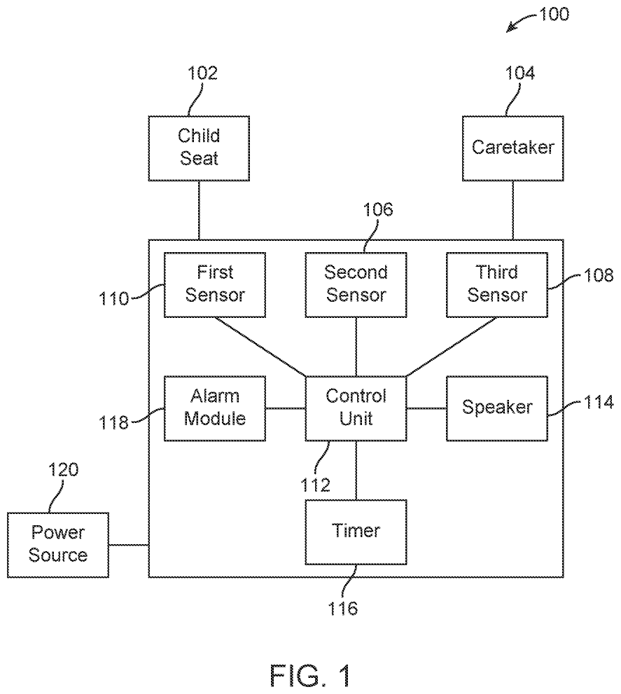

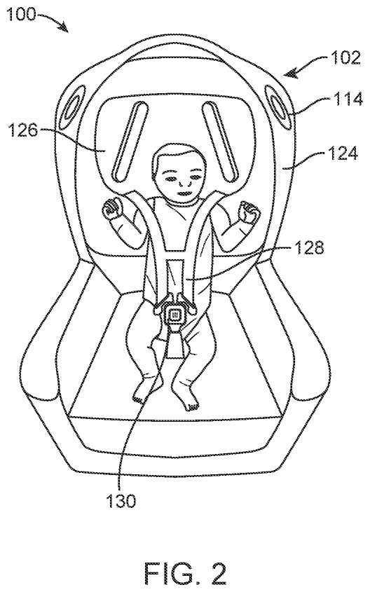

FIG. 1 exemplarily illustrates a block diagram of a child car seat alert system 100 for indicating and alerting the presence of child in a child car seat 102 of a vehicle, according to an embodiment of the present invention. The system 100 comprises the child car seat 102 having at least one first sensor 110 configured to detect a presence of child and at least one second sensor 106 configured to detect fastening of seatbelt 128 (shown in FIG. 2) of the child car seat 102. The system 100 further comprises at least one third sensor 108 configured to detect a first state and a second state of the vehicle. The first state refers to the vehicle being in a parked state and having the presence of a driver, for example, a caretaker 104 within the vehicle. The second state refers to the vehicle being in a parked state and having the absence of the caretaker 104 within the vehicle. The system 100 is further connected to the ignition system of the vehicle to detect whether the vehicle is at rest or the vehicle is in operation.

The system 100 further comprises an alarm module 118 configured to receive power from a power source 120. The system 100 further comprises a control unit 112. The control unit 112 is in communication with the alarm module 118, the first sensor 110, the second sensor 106 and the third sensor 108. The system 100 further comprises one or more speakers 114 and a timer 116. The system 100 is electrically connected to the power source 120. In one embodiment, the power source 120 is a rechargeable battery 146. In another embodiment, the system 100 is configured to receive power from a power system of the vehicle. The power system of the vehicle includes an engine.

The control unit 112 is configured to activate the alarm module 118 on detecting the presence of child in the car seat 102 and the seatbelt 128 fastened to the child car seat 102. The control unit 112 is further configured to prompt the alarm module 118 to provide a first alert on detecting the first state to remind the caretaker 104 to collect the child while exiting the vehicle. The control unit 112 is further configured to prompt the alarm module 118 to provide a second alert on detecting the second state to indicate the child is left unattended in the child car seat 102. The second alert is broadcasted until the child is collected from the vehicle. In an embodiment, the second alert is broadcasted, periodically. In another embodiment, the second alert is broadcasted, for example, periodically for every 15 seconds, until the child is collected from the vehicle. In one embodiment, the first alert and the second alert are provided in the form of an audible alert. In another embodiment, the first alert and the second alert are provided in the form of music.

The system 100 further comprises a recorder configured to enable the caretaker 104 to record the name of the child. The recorder is coupled to the alarm module 118 and speaker 114. The alarm module 118 is configured to provide alert using the child's name. The system 100 provides protection to the babies and the children traveling with the caregiver 104.

FIG. 2 exemplarily illustrates a perspective view of the child car seat 102 with a child, according to an embodiment of the present invention. The child car seat 102 could be of any type, and for any aged child and could be a forward facing, a rearward facing, a convertible, or a booster seat. The seat 102 could be selected from a group, including, but not limited to infant seat, toddler seat, convertible seat, infant booster seat and toddler booster seat. The seat 102 comprises a shell 122, a padded cloth 124 enclosing the shell 122, and a head support plate 126. The child is placed in the child car seat 102 and is appropriately secured to the car seat 102 via the seatbelt 128 and a seatbelt button 130. The seatbelt button 130 is in communication with the control unit 112 and the power source 120. The seatbelt button 130 is configured to provide an indication when the seatbelt 128 is fastened to the child car seat 102. The seatbelt button 130 is further configured to provide an indication when the seatbelt 128 is unfastened from the child car seat 102.

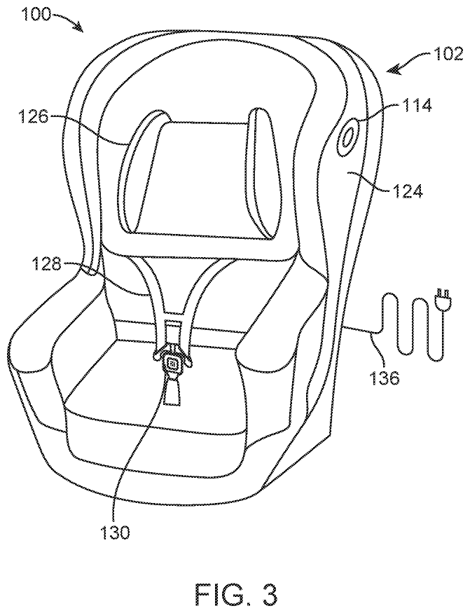

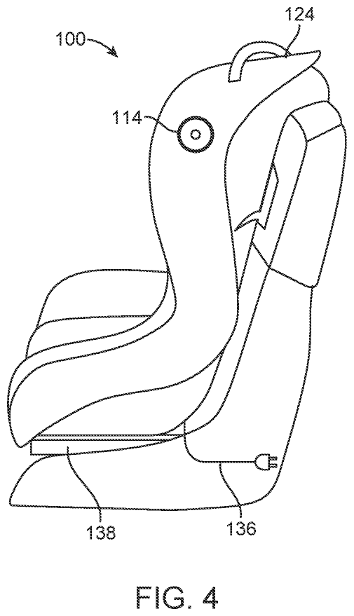

FIG. 3 exemplarily illustrates a perspective view of the child car seat 102 of FIG. 2. FIG. 4 exemplarily illustrates a side view of the child car seat 102 of FIG. 2. Referring to FIG. 3 and FIG. 4, the system 100 further comprises a cord 136 and the speakers 114. The speaker 114 is electrically connected to the power source 120. The speaker 114 is configured to provide at least one of the first alert and the second alert. The cord 136 is configured to electrically connect the speaker 114 to a power socket.

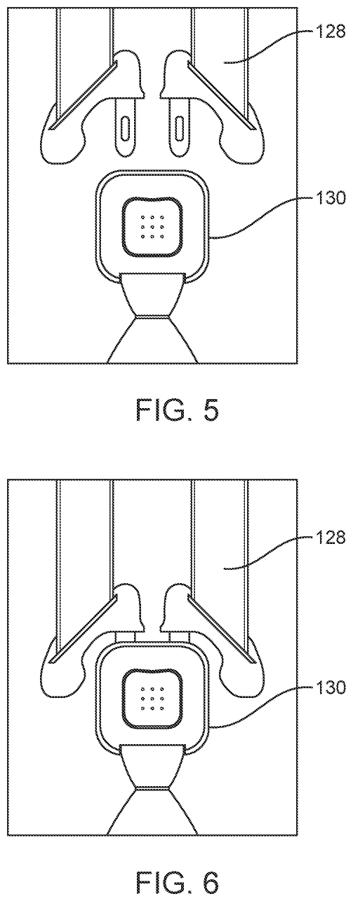

FIG. 5 exemplarily illustrates the seatbelt 128 of the child car seat 102 of FIG. 2 in an unfastened state. The control unit 112 is configured to check if the seatbelt 128 is unfastened and enables the seatbelt button 128 to indicate that the seatbelt 128 is unfastened. FIG. 6 exemplarily illustrates the seatbelt 128 of the child car seat 102 of FIG. 2 in a fastened state. The control unit 112 is configured to check if the seatbelt 128 is fastened and enables the seatbelt button 128 to indicate that the seatbelt 128 is fastened. In another embodiment, the system 100 is configured to provide a visual indication regarding the fastened and the unfastened state of the seatbelt 128. In another embodiment, the system 100 is configured to provide an audible indication regarding the fastened and the unfastened state of the seatbelt 128. The system 100 is configured to provide an audible alert when a malfunction has occurred in an unsecured seatbelt 128 or the child was inadvertently left behind, in a parked vehicle.

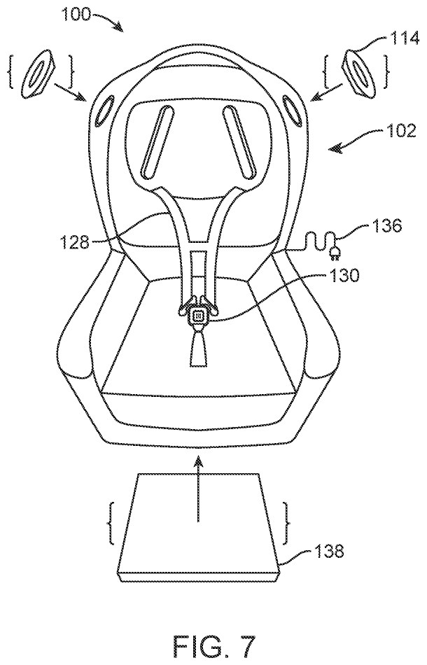

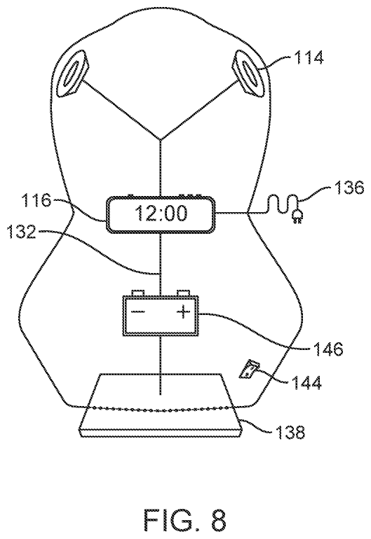

FIG. 7 exemplarily illustrates the arrangement of the first sensor 110, for example, a weight sensor 138 and the speaker 114 of the child car seat 102 of FIG. 2. The weight sensor 138 is configured to detect the presence and absence of child in the child car seat 102 and transmit the data related to the presence and absence of the child to the control unit 112. The speaker 114 is configured to provide the first alert and the second alert. FIG. 8 exemplarily illustrates the connection between the components of the child car seat alert system 100. The system 100 including one or more speakers 114, the battery 146, the timer 116, a manual switch 144, the weight sensor 138, the cord 136 connected to one another via the wire 132. The manual switch 144 allows the user to turn on and turn off the system 100 manually.

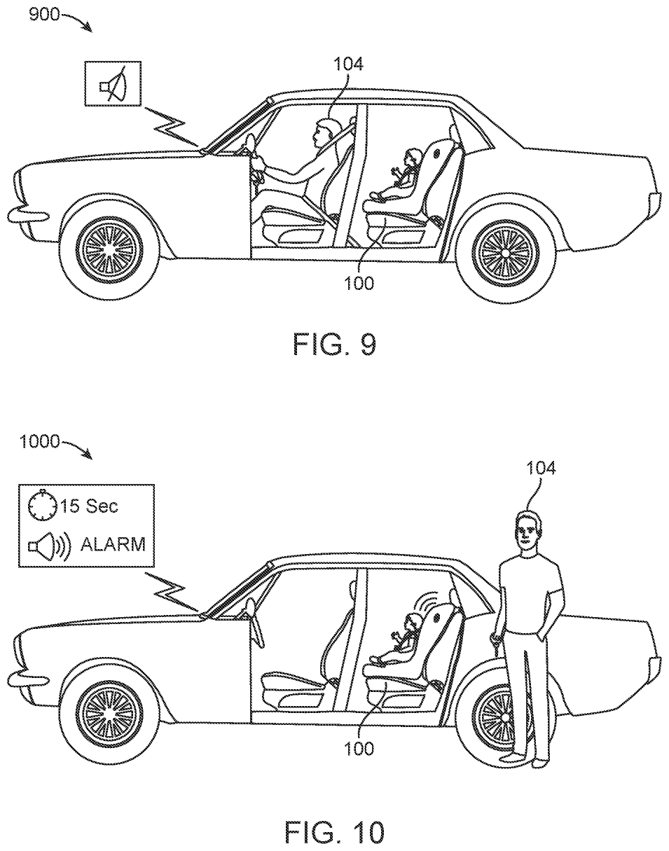

FIG. 9 exemplarily illustrates an environment 900 where the alarm module 118 is restricted to provide alert when the child and the caretaker 104 is within a moving vehicle. The system 100 is configured to detect the presence of child in the child car seat 102 and the presence of caretaker 104 in the vehicle. If the vehicle is in motion while detecting the presence of child in the child car seat 102 and the presence of caretaker 104 in the vehicle, the alarm module 118 does not provide alert.

FIG. 10 exemplarily illustrates an environment 1000 where the alarm module 118 is providing alert when the system 100 of FIG. 1 detects that the child is within the vehicle, and the caretaker 104 has left the vehicle. The system 100 detects that the vehicle is parked, the presence of child in the child car seat 102 and the absence of the caretaker 104 in the vehicle, the alarm module 118 is configured to provide the second alert to indicate the child is left unattended in the child car seat 102. The second alert is broadcasted, for example, periodically for every 15 seconds, until the child is collected from the vehicle.

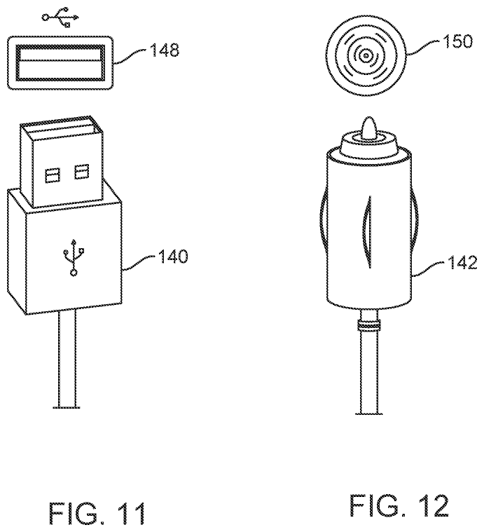

FIG. 11 exemplarily illustrates a USB cable 140 of the system 100 of FIG. 1 for connecting to a USB port 148 of the vehicle. FIG. 12 exemplarily illustrates a cable 142 of the system 100 of FIG. 1 for connecting to a cigarette lighter port 150. The cord 136 is connected to the power socket of the power source 120. Referring to FIG. 11 and FIG. 12, in one example, the power socket includes, but not limited to, the USB socket 148 and the cigarette lighter port 150. In one example, the system 100 is connect to the power socket via at least one of the cables including, but not limited to, USB cable 140 and the cable 142 to connect with the cigarette lighter port 150.

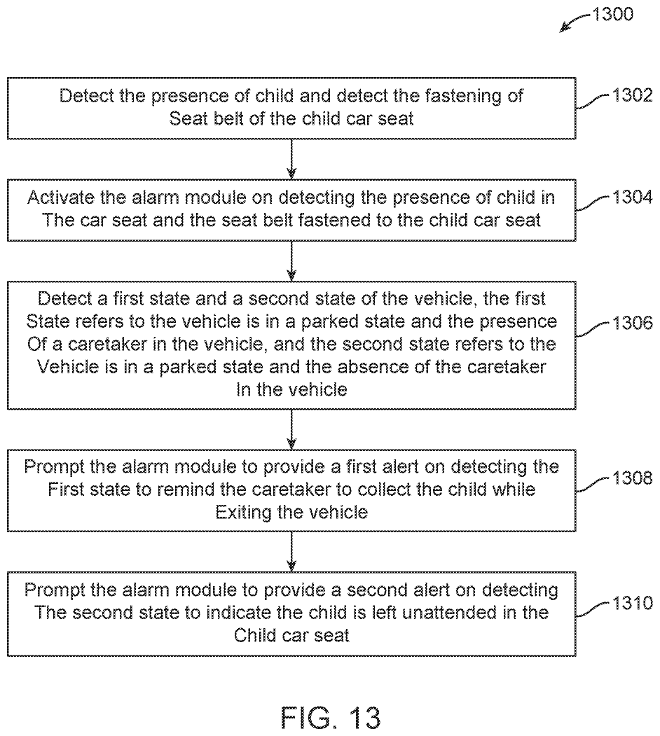

FIG. 13 exemplarily illustrates a method 1300 for indicating and alerting the presence of child in a child car seat of a vehicle, according to an embodiment of the present invention. The method 1300 is executed by the system 100. At step 1302, the system 100 is configured to detect the presence of child via the first sensor 110, and detect the fastening of seatbelt 128 of the child car seat 102 via the second sensor 106. At step 1304, the system 100 is configured to activate the alarm module 118 on detecting the presence of child in the car seat 102 and the seatbelt 128 fastened to the child car seat 102. At step 1306, the system 100 is configured to detect a first state and a second state of the vehicle via the third sensor 108. The first state refers to the vehicle being in a parked state and the presence of the caretaker 104 in the vehicle. The second state refers to the vehicle being in a parked state and the absence of the caretaker 104 in the vehicle. At step 1308, the control unit 112 of the system 100 is configured to prompt the alarm module 118 to provide a first alert on detecting the first state to remind the caretaker 104 to collect the child while exiting the vehicle. At step 1310, the control unit 112 of the system 100 is configured to prompt the alarm module 118 to provide a second alert on detecting the second state to indicate the child is left unattended in the child car seat 102. The second alert is broadcasted until the child is collected from the vehicle.

Advantageously, the system 100 is configured to provide an audible alert when a malfunction has occurred in an unsecured seatbelt 128 or the child was inadvertently left behind, in a parked vehicle. The system 100 is configured to operate using a separate power source 120, so the system 100 operates even the vehicle engine is in off condition. The system 100 is configured to provide alert before the caretaker 104 reaches his/her destination to remind the caretaker of the presence of the child. The system provides alert when the caretaker reaches the destination to indicate and alert the caretaker 104 regarding the presence of child.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1. A child car seat alert system for indicating and alerting the presence of child in a vehicle, comprising:
at least one child car seat having at least one first sensor configured to detect a presence of child and at least one second sensor configured to detect fastening of seatbelt of the child car seat;
at least one third sensor configured to detect a first state and a second state of the vehicle, wherein the first state refers to the vehicle being in a parked state and the presence of a caretaker in the vehicle, and the second state refers to the vehicle being in a parked state and the absence of the caretaker in the vehicle;
an alarm module configured to receive power from a power source, and
a control unit is in communication with the alarm module, the first sensor, the second sensor and the third sensor, the control unit is configured to:
activate the alarm module on detecting the presence of child in the car seat and the seatbelt fastened to the child car seat;
prompt the alarm module to provide a first alert on detecting the first state to remind the caretaker to collect the child while exiting the vehicle, and
prompt the alarm module to provide a second alert on detecting the second state to indicate the child is left unattended in the child car seat, wherein the second alert is broadcasted until the child is collected from the vehicle.

2. The alert system of claim 1, wherein the first sensor is a weight sensor.

3. The alert system of claim 1, wherein the alert is at least one of an audible alert and a musical type audible alert.

4. The alert system of claim 1, wherein the power source is a rechargeable power source.

5. The alert system of claim 1, further comprises a speaker to provide at least one of the first alert and the second alert, wherein the speaker is electrically connected to the power source.

6. The alert system of claim 5, wherein the speaker comprises a cord to electrically connect the speaker to a power socket, the power socket is at least one of a USB port, and a cigarette lighter port of the vehicle.

7. The alert system of claim 1, further comprises a seatbelt button in communication with the control unit, the seatbelt is configured to provide an indication when the seatbelt is fastened to the child car seat, and provide an indication when the seatbelt is unfastened from the child car seat.

8. The alert system of claim 1, further comprises a timer in communication with the control unit.

9. The alert system of claim 1, wherein the control unit is configured to deactivate the alarm module on collecting the child from the child car seat.

10. The alert system of claim 1, wherein the control unit is electrically connected to the power source to receive power supply from the power source.

11. The alert system of claim 1, wherein the control unit is configured to receive power from a power system of the vehicle, wherein the power system includes an engine.

12. The alert system of claim 1, further comprises a recorder in communication with the control unit, the recorder is configured to enable the caretaker to record the name of the child.

13. The alert system of claim 1, is configured to provide alert using the name of the child.

14. The alert system of claim 1, is configured to provide alert regarding the malfunction of the seatbelt.
